(19) United States
(12) Patent Application Publication
(10) Pub. No.: US 2023/0263129 A1
(43) Pub. Date: Aug. 24, 2023

(54) MODULAR SPLICING BOARD AND PET HOUSE

(71) Applicant: HONGHAO YU, SHENZHEN (CN)

(72) Inventor: HONGHAO YU, SHENZHEN (CN)

(21) Appl. No.: 17/679,135

(22) Filed: Feb. 24, 2022

(51) Int. Cl. A01K 1/03

(52) U.S. Cl. CPC A01K 1/03

(57) ABSTRACT

The invention discloses a modular splicing board and pet house, wherein the pet house is formed by splicing a plurality of modular splicing boards, the modular splicing board comprises a splicing board body, the splicing board body is in the shape of a regular polygon, a first connecting structure and/or a second connecting structure are provided on each side of the splicing board body, and the first connecting structure is used for connecting with the second connecting structure on another splicing board body; a first connecting structure and/or a second connecting structure are provided on each side of the splicing board body which is in the shape of a regular polygon, and the first connecting structure on the splicing board body is connected to the first connecting structure on another splicing board body, so that the assembly is convenient, and a pet house with various structures can be assembled.

### TECHNICAL FIELD

The invention relates to the technical field of pet utensils, and in particular to a modular splicing board and pet house.

### BACKGROUND ART

With the improvement of living standard, people pay more and more attention to leisure life and interest cultivation. With the change of traditional family structure and the increase of work pressure, more and more people are betting their emotions on pets. The interdependence between people and pets will grow stronger with the passage of time. It is expected that the number of pet owners will usher in an explosive growth in the future, but while pets bring joy to people, they also give owners a certain sense of responsibility. At present, many pets are kept in cages or boxes whose living environment is poor, which greatly reduces the comfort of pets. Therefore, the pet houses come into being, but most of the pet houses on the market are made of composite boards or wood fixedly connected into one piece, which is composed of a single combination of several integral parts. Moreover, the appearance of this kind of pet house is relatively fixed, and the structure style is single; and most of these pet houses are bulky and inconvenient to assemble and carry.

### SUMMARY

The technical problem to be solved by the invention is to provide a modular splicing board and pet house to solve the problem of a single structural style of the pet house in the prior art.

In order to solve the above technical problem, the technical solution adopted by the invention is: a modular splicing board comprising a splicing board body, the splicing board body being in the shape of a regular polygon, a first connecting structure and/or a second connecting structure being provided on each side of the splicing board body, the first connecting structure being used for connecting with the second connecting structure on another splicing board body.

In order to solve the above technical problem, the invention also provides a pet house formed by splicing a plurality of modular splicing boards, the modular splicing boards being the above modular splicing boards.

The advantageous effect of the invention is that the modular splicing board and pet house provided by the invention have the feature of rich structural styles, a first connecting structure and/or a second connecting structure may be provided on each side of the splicing board body which is in the shape of a regular polygon, and the first connecting structure on the splicing board body is connected to the first connecting structure on another splicing board body, so that the assembly is convenient, and a pet house with various structures can be assembled, thereby enriching the structural styles of the pet house and enhancing the interest of a user in raising pets.

### BRIEF DESCRIPTION OF THE DRAWINGS

FIG. 1 is a schematic view showing a structure of a side of a modular splicing board in the Embodiment I of the invention;

FIG. 2 is a schematic view showing a structure of another side of a modular splicing board in the Embodiment I of the invention;

FIG. 3 is a schematic view showing a structure of a side of a modular splicing board of another structure in the Embodiment I of the invention;

FIG. 4 is a schematic view showing a structure of another side of a modular splicing board of another structure in the Embodiment I of the invention;

FIG. 5 is a schematic view showing a structure of a pet house in the Embodiment I of the invention;

FIG. 6 is a partial sectional view showing a structure of a pet house in the Embodiment I of the invention;

FIG. 7 is a schematic view showing a structure of a pet house in the Embodiment I of the invention;

FIG. 8 is a schematic view showing a structure of a pet house of another structure in the Embodiment I of the invention.

### DETAILED DESCRIPTION

In order to explain the technical content, the achieved objects, and the effects of the invention in detail, the embodiments will be described below with reference to the accompanying drawings.

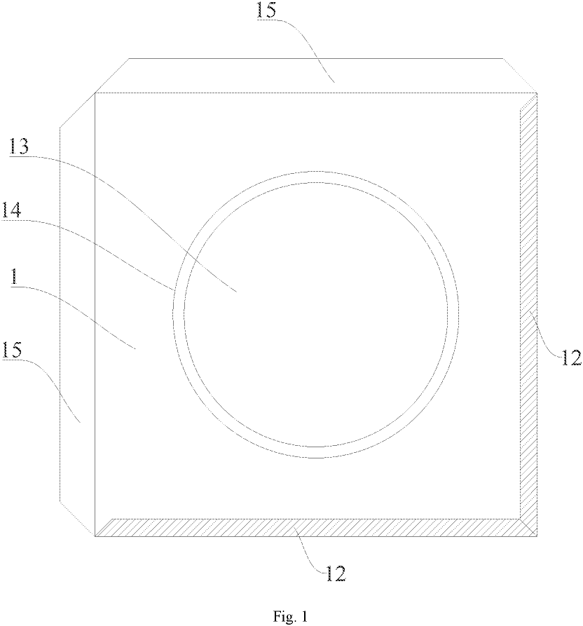

With reference to FIGS. 1 to 8, a modular splicing board comprises a splicing board body 1, the splicing board body 1 may be in the shape of a regular polygon, a first connecting structure and/or a second connecting structure is provided on each side of the splicing board body 1, and the first connecting structure is used for connecting with the second connecting structure on another splicing board body 1.

As apparent from the above description, the advantageous effect of the invention is that a first connecting structure and/or a second connecting structure are provided on each side of the splicing board body 1 which is in the shape of a regular polygon, and the first connecting structure on the splicing board body 1 is connected to the first connecting structure on another splicing board body 1, so that the assembly is convenient, and a pet house with various structures can be assembled, thereby enriching the structural styles of the pet house and enhancing the interest of a user in raising pets.

Further, the first connecting structure is a velcro loop 11 extending to the outside of the splicing board body 1, and the second connecting structure is a velcro hook 12; the velcro loop 11 faces one side of the splicing board body 1 and the velcro hook 12 faces the other side of the splicing board body 1.

It can be seen from the above description that the splicing between the splicing board body 1 and another splicing board body 1 is facilitated by making the velcro loop 11 face one side of the splicing board body 1 and the velcro hook 12 face the other side of the splicing board body 1, and the velcro loop 11 extends to the outside of the splicing board body 1, enhancing the stability of the connection between the velcro loop 11 and the velcro hook 12, and improving the structural strength.

Further, both the first connecting structure and the second connecting structure are in the shape of an isosceles trapezoid.

It can be seen from the above description that the shapes of the first connecting structure and the second connecting structure can be set according to practical application requirements.

Further, the splicing board body 1 comprises a plastic layer 16 and a fleece layer 17 attached to two opposite sides of the plastic layer 16.

It can be seen from the above description that the splicing board body 1 has a light structure and is convenient for assembly and carrying.

Further, the edges of the plastic layer 16 are provided with a regular polygonal frame 18, which is wrapped in the fleece layer 17.

It can be seen from the above description that the regular polygonal frame 18 can enhance the structural strength of the splicing board body 1.

Further, the material of the regular polygonal frame 18 is a metal material, a plastic material or a wood material.

It can be seen from the above description that the material of the regular polygonal frame 18 can be set according to practical application requirements.

Further, the splicing board body 1 is provided with an inlet and outlet 13 for the pet to enter and exit.

Further, the edges of the inlet and outlet 13 are sewn with a reinforcement line 14.

It can be seen from the above description that the reinforcement line 14 facilitates the reinforcement of the structure of the inlet and outlet 13, and reduces the risk of the splicing board body 1 being scratched when pets enter and exit the inlet and outlet 13. A pet house is formed by splicing a plurality of modular splicing boards, and the modular splicing boards are the above modular splicing boards.

### Embodiment I

With reference to FIGS. 1 to 8, the Embodiment I of the invention is a pet house for a pet to live and play, the pet house may be formed by splicing a plurality of modular splicing boards, the modular splicing boards comprise a splicing board body 1, the splicing board body 1 is in the shape of a regular polygon, a first connecting structure and/or a second connecting structure are provided on each side of the splicing board body 1, and the first connecting structure is used for connecting with the second connecting structure on another splicing board body 1; alternatively, the first connecting structure and the second connecting structure may be at least one of a buckle, a velcro, a zipper.

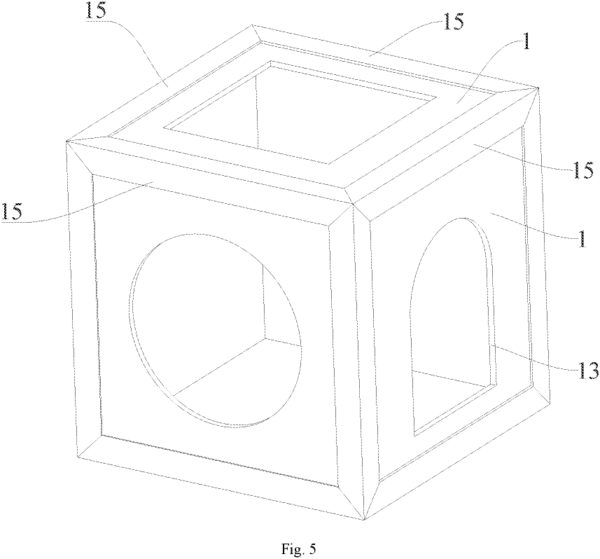

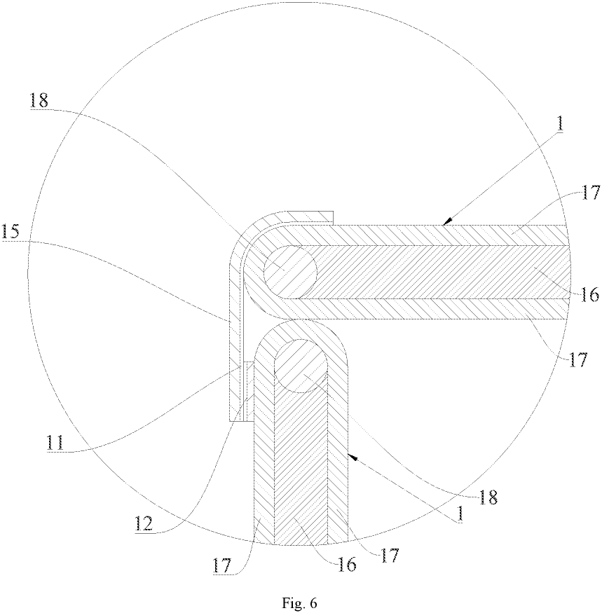

In conjunction with FIGS. 5 and 6, in the present embodiment, the first connecting structure is a velcro loop 11 extending to the outside of the splicing board body 1, and the second connecting structure is a velcro hook 12; the velcro loop 11 faces one side of the splicing board body 1 and the velcro hook 12 faces the other side of the splicing board body 1, thus facilitating the splicing between the splicing board body 1 and another splicing board body 1, and the velcro loop 11 extends to the outside of the splicing board body 1, enhancing the stability of the connection between the velcro loop 11 and the velcro hook 12, and improving the structural strength; specifically, the splicing board body 1 is provided with an extension portion 15 extending along the outside thereof, and the velcro loop 11 is provided on one side of the extension portion 15; in detail, both the first connecting structure and the second connecting structure are in the shape of an isosceles trapezoid; in addition, the shape of the first connecting structure and the second connecting structure can also be rectangular, and the shapes of the first connecting structure and the second connecting structure can be set according to practical application requirements.

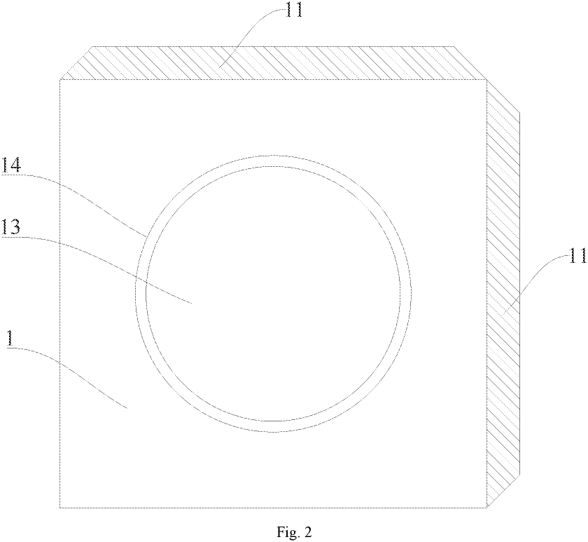

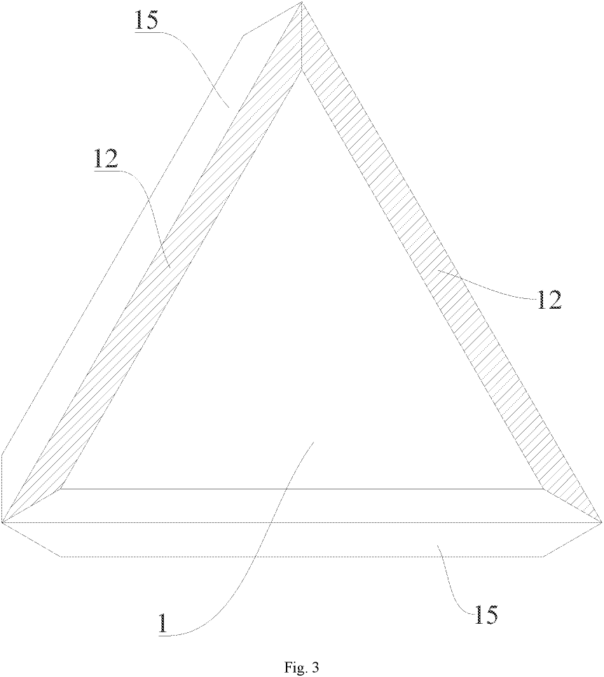

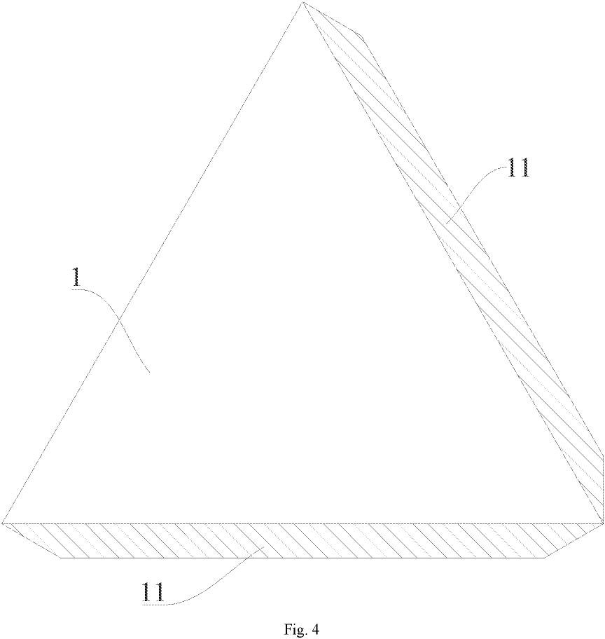

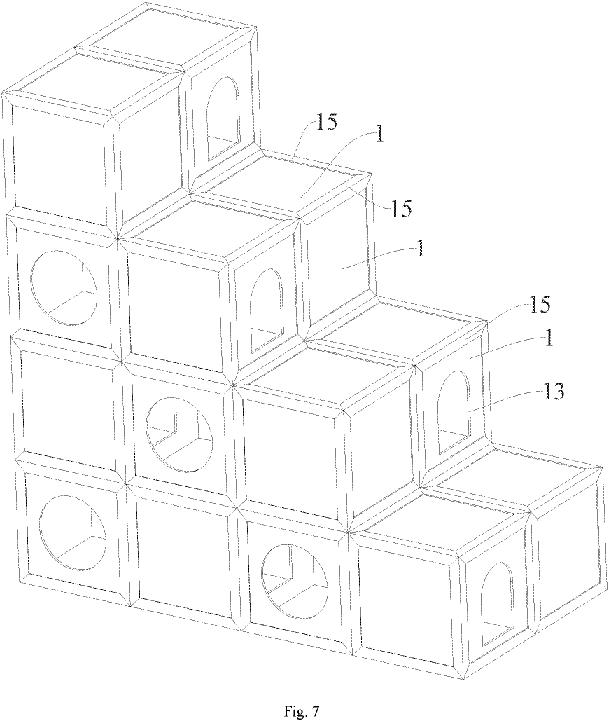

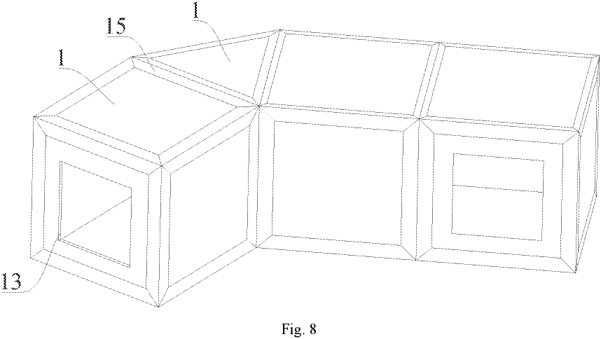

Alternatively, the shape of the splicing board body 1 can be a regular triangle (as shown in FIGS. 3 and 4), a square (as shown in FIGS. 1 and 2), a regular pentagon, a regular hexagon, etc. and the shape of the splicing board body 1 can be specifically set according to practical application requirements; for example, when the shape of the splicing board body 1 is a regular triangle, the velcro loop 11 is provided on two sides of the splicing board body 1, and the velcro hook 12 is provided on the other side; or the velcro loop 11 is provided on one side of the splicing board body 1, and the velcro hook 12 is provided on the other two sides; when the shape of the splicing board body 1 is a square, two of the velcro loop 11 can be provided on one group of adjacent sides of the splicing board body 1, and two of the velcro hook 12 can be provided on another group of adjacent sides of the splicing board body 1; in practical use, a plurality of the splicing board bodies 1 of the same shape can be selectively spliced into a pet house having a three-dimensional shape (as shown in FIGS. 5 and 7); alternatively, the splicing board bodies 1 having different shapes may be mixed and spliced (as shown in FIG. 8).

Preferably, in conjunction with FIG. 6, the splicing board body 1 comprises a plastic layer 16 and a fleece layer 17 attached to two opposite sides of the plastic layer 16, so as to make the spliced pet house have a light structure and convenient for assembly and carrying; specifically, the edge of the plastic layer 16 is further provided with a regular polygonal frame 18, which is wrapped in the fleece layer 17, and the regular polygonal frame 18 can enhance the structural strength of the splicing board body 1; alternatively, the material of the regular polygonal frame 18 is a metal material, a plastic material or a wood material, and the material of the regular polygonal frame 18 can be specifically set according to practical application requirements; in detail, the splicing board body 1 is further provided with an inlet and outlet 13 for the pet to enter and exit, and in order to prevent the pet from scratching the splicing board body 1 when entering and exiting the inlet and outlet 13, the edges of the inlet and outlet 13 are sewn with a reinforcement line 14, and the reinforcement line 14 is used for reinforcing the structure of the inlet and outlet 13.

In summary, the modular splicing board and pet house provided by the invention have the feature of rich structural styles, a first connecting structure and/or a second connecting structure may be provided on each side of the splicing board body which is in the shape of a regular polygon, and the first connecting structure on the splicing board body is connected to the first connecting structure on another splicing board body, so that the assembly is convenient, and a pet house with various structures can be assembled, thereby enriching the structural styles of the pet house and enhancing the interest of a user in raising pets; the splicing between the splicing board body and another splicing board body is facilitated by making the velcro loop face one side of the splicing board body and the velcro hook face the other side of the splicing board body, and the velcro loop extends to the outside of the splicing board body, enhancing the stability of the connection between the velcro loop and the velcro hook, and improving the structural strength.

The above description is only an embodiment of the invention, and is not intended to limit the scope of the invention, and all equivalent modifications made by using the contents of the specification and the drawings of the invention, or the direct or indirect application thereof in the related technical fields, are all included in the scope of the invention.

1. A modular splicing board, comprising a splicing board body, the splicing board body being in the shape of a regular polygon, a first connecting structure and/or a second connecting structure being provided on each side of the splicing board body, the first connecting structure being used for connecting with the second connecting structure on another splicing board body.

2. The modular splicing board of claim 1, wherein the first connecting structure is a velcro loop extending to the outside of the splicing board body, and the second connecting structure is a velcro hook; the velcro loop faces one side of the splicing board body and the velcro hook faces the other side of the splicing board body.

3. The modular splicing board of claim 2, wherein both the first connecting structure and the second connecting structure are in the shape of an isosceles trapezoid.

4. The modular splicing board of claim 1, wherein the splicing board body comprises a plastic layer and a fleece layer attached to two opposite sides of the plastic layer.

5. The modular splicing board of claim 4, wherein the edges of the plastic layer are further provided with a regular polygonal frame, which is wrapped in the fleece layer.

6. The modular splicing board of claim 5, wherein the material of the regular polygonal frame is a metal material, a plastic material or a wood material.

7. The modular splicing board of claim 4, wherein the splicing board body is further provided with an inlet and outlet for the pet to enter and exit.

8. The modular splicing board of claim 7, wherein the edges of the inlet and outlet are sewn with a reinforcement line.

9. A pet house, formed by splicing a plurality of modular splicing boards, wherein the modular splicing board is the modular splicing board of claim 1.

10. The pet house of claim 9, wherein the first connecting structure is a velcro loop extending to the outside of the splicing board body, and the second connecting structure is a velcro hook; the velcro loop faces one side of the splicing board body and the velcro hook faces the other side of the splicing board body.

11. The pet house of claim 10, wherein both the first connecting structure and the second connecting structure are in the shape of an isosceles trapezoid.

12. The pet house of claim 9, wherein the splicing board body comprises a plastic layer and a fleece layer attached to two opposite sides of the plastic layer.

13. The pet house of claim 12, wherein the edges of the plastic layer are further are provided with a regular polygonal frame, which is wrapped in the fleece layer.

14. The pet house of claim 13, wherein the material of the regular polygonal frame is a metal material, a plastic material or a wood material.

15. The pet house of claim 12, wherein the splicing board body is further provided with an inlet and outlet for the pet to enter and exit.

16. The pet house of claim 15, wherein the edges of the inlet and outlet are sewn with a reinforcement line.
